(19) United States
(12) Patent Application Publication
(10) Pub. No.: US 2010/0115756 A1
(43) Pub. Date: May 13, 2010

(54) METHOD FOR THE PRODUCTION OF GRATINGS

(76) Inventor: Wolfgang Meiser, Tholey (DE)

Correspondence Address: COLLARD & ROE, P.C., 1077 NORTHERN BOULEVARD, ROSLYN, NY, 11576, US

(21) Appl. No.: 12/449,364

(22) PCT Filed: Feb. 11, 2008
(86) PCT No.: PCT/DE2008/000232

§ 371 Date: Aug. 4, 2009

(30) Foreign Application Priority Data
Feb. 9, 2007 (DE) 10 2007 007 175.4

(51) Int. Cl. B23P 17/00

(52) U.S. Cl. 29/458

(57) ABSTRACT

The invention relates to a method for the production of gratings.

To provide an improved method for the production of gratings, a solution is provided within the scope of the invention, which comprises the following steps in the following order:
Hot-dip galvanizing of the bearing-bar strip or the bearing- and cross-bar strip,
Punching the bearing bars or the bearing and cross bars and cutting them to length,
Pressing of the grating,
Banding of the grating.

This sequence of steps, in conjunction with modifications within the steps, makes for improved corrosion protection and higher dimensional accuracy. It is no longer necessary to straighten the gratings.

The invention relates to a method for the production of gratings.

Prior art gratings are made as follows: the bearing bars or the bearing bars and the cross bars are punched and cut to length, after which the grating is pressed. Then the grating is banded (provided with a surround) and, in the last manufacturing stage, galvanized by the hot-dip method.

This process has the disadvantage that the galvanizing step can cause thermal distortion of the grating. In consequence, gratings sometimes have to be straightened so that they comply with the required tolerances according to RAL. The straightening process involves the risk of creating microcracks in the zinc coating, in the area of which corrosion can occur. Another disadvantage of the prior art process is that, in the case of close-mesh gratings, so called “zinc smears” may occur, which form in the spaces between the bars and necessitate post-working. Finally, there is the frequent problem of “zinc peaks”, which pose one of the main risks of injury by galvanized parts.

The object of the invention is thus to provide an improved method for the production of gratings, which, if possible, overcomes the disadvantages described above.

This object is established within the scope of the invention by means of a method for the production of gratings which comprises the following steps in the following order:
Hot-dip galvanizing of the bearing-bar strip or the bearing- and cross-bar strip,
Punching the bearing bars or the bearing and cross bars and cutting them to length,
Pressing of the grating,
Banding of the grating.

This method has an advantage over the prior art with regard to corrosion protection: since the bearing-bar strip or the bearing- and cross-bar strip is galvanized in the split-strip condition, all surfaces and edges are protected against corrosion. Surprisingly, it turns out that even after the bearing bars or the bearing and cross bars have been cut to length, the notched surfaces are adequately protected against corrosion by way of cathodic protection.

Another advantage of the method according to the invention is that it is no longer necessary to straighten the grating because the galvanizing step takes place before pressing of the grating. The danger of microcracks forming is thus eliminated. Zinc smears and zinc peaks are not formed, either, in the method according to the invention, because the strip metal and not the finished grating is galvanized.

An important advantage of the invention consists ultimately in that gratings manufactured according to the method of the invention feature excellent evenness, and, angularity and diagonal distortion are around 70% below the permissible tolerances according to RAL and

DIN.

A useful embodiment of the invention consists in that the bearing-bar strip or the bearing- and cross-bar strip is hot-dip galvanized in a continuous process.

In this process, a high material-throughput rate is obtained, combined with a high-quality zinc coating, industrial-scale manufacturing requires.

It has proved advantageous within the scope of the invention for the cutting punch for punching the bearing bars or the bearing and cross bars to be configured as a longish, flat element that features rotationally symmetric reductions at its upper and lower free ends.

A preferred embodiment of the invention consists in that, in the area adjacent to each of the areas with the smaller cross-section, the cutting punch features a depression which is on the opposite side to that featuring a reduction.

Configuring the cutting punch in this way significantly improves the locking of bearing and cross bars.

It is within the scope of the invention that for banding the grating, a welding temperature is selected which is below the vaporisation temperature of zinc.

In this connection it has proved advantageous to use the welding method known as “MIG soldering of galvanized steels with A 202 M” for banding the grating.

This process is permitted by the German Technical Inspection Agency TÜV, and is used, for example in container construction, for safety-relevant parts, as well as in the automobile industry.

A preferred embodiment of the invention is explained below in more detail by reference to drawings.

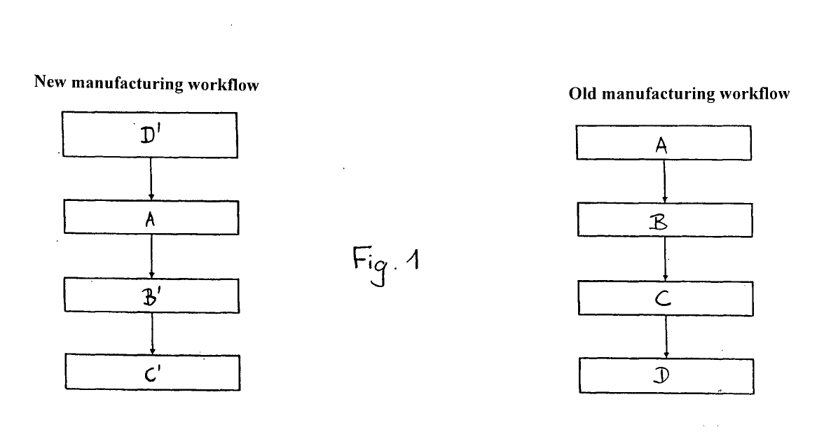

FIG. 1 shows a flowchart of the method according to the invention and, for comparison, one of the prior-art method.

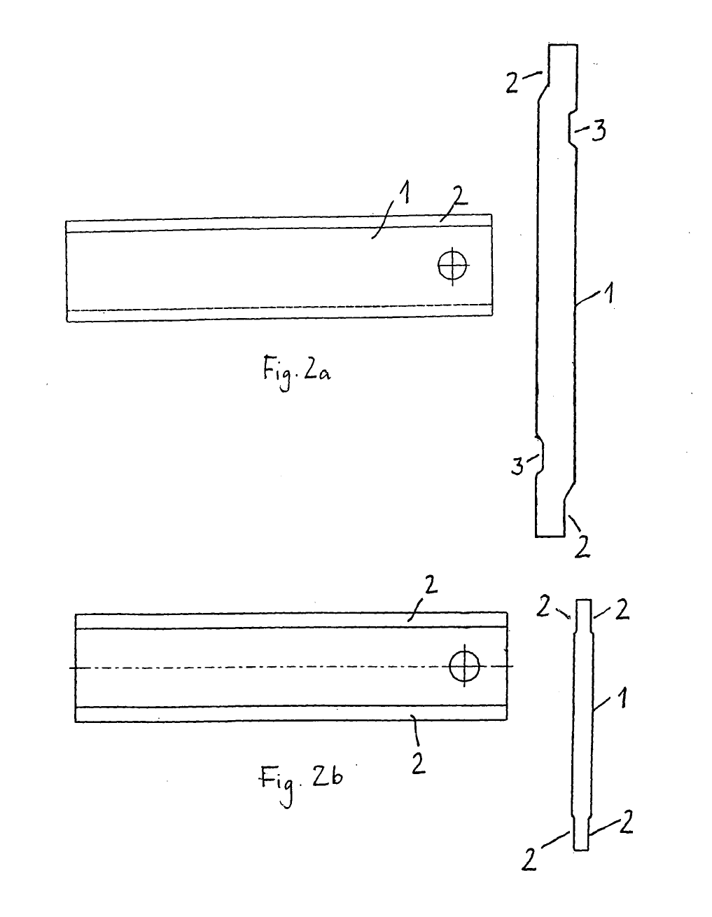

FIG. 2 illustrates the cutting punch according to the invention.

As is evident from FIG. 1, both the method of the invention (new manufacturing workflow) and the method according to the prior art (old manufacturing workflow) comprise four steps. However, the sequence of the steps is different, and there are also differences in the individual steps themselves.

Prior-art gratings are made as follows: first of all, the bearing bars or the bearing and cross bars are punched and cut to length (step A). The next step is the pressing of the grating (step B). This is followed by banding of the grating (step C) and, lastly, by galvanizing of the grating (step D). Typically, galvanizing is done by means of the hot-dip process. Subsequently, the gratings often still have to be straightened and, in some cases, zinc smears and zinc peaks have to be removed in a post-working operation (not shown).

With the method of the invention, by contrast, not the finished grating but the bearing-bar strip or the bearing- and cross-bar strip is galvanized (step D′). For reasons of the much simpler geometry, better corrosion protection is obtained than is possible for a complex part. Plus, problems associated with the formation of zinc smears and zinc peaks are eliminated.

In the next step, the bearing bars or the bearing and cross bars are punched and cut to length (step A), which corresponds to the first step of the old manufacturing workflow. Surprisingly, it turns out that thanks to what is known as cathodic protection, adequate corrosion protection is ensured at the notched surfaces, too.

The following step, pressing of the grating (step B′) corresponds basically to the second step of the old manufacturing workflow. However, the differently configured cutting punch (see explanations for FIG. 2) makes for better locking of bearing and cross bars.

In the last step, the grating is then banded (step C′). In the method according to the invention, special welding parameters and filler metals are used here. The welding parameters (soldering parameters) are as follows:
Wire electrode FONTRAGEN A 202 M (DIN 1733: SG-CU Si 3)
Welding time 120 ms (6 periods), i.e. half the welding time needed in the prior art-method
Current intensity: approx. 30-40% of the welding current according to the prior art
Welding temperature beneath the vaporizing temperature of zinc
   This welding method, which is referred to as MIG soldering of galvanized steels with A 202 M, is permitted by the German TÜV.

With the method according to the invention, there is no need either to straighten the gratings or to remove zinc smears or peaks.

FIG. 2 illustrates the differently configured cutting punch according to the invention.

Whereas a conventional cutting punch (FIG. 2b) is configured as a longish, flat element (1) that has reductions (2) showing mirror symmetry at its upper and lower free ends, the cutting punch according to this invention (FIG. 2a) has, at its free ends, reductions (2) that show rotational symmetry. This means that the decrease in cross-section in the area of the free ends, which constitutes the reduction (2), is only effected on one side in each case. Apart from this difference, the cutting punch according to the invention has, in the areas adjacent to each of the two areas with the smaller cross-section, depressions (3) that are located in each case on the side opposite the reduction.

1. Method for the production of gratings, comprising the following steps in the following order:
Hot-dip galvanizing of the bearing-bar strip or the bearing- and cross-bar strip,
Punching the bearing bars or the bearing and cross bars and cutting them to length,
Pressing of the grating,
Banding of the grating.

2. Method according to claim 1, characterised in that the bearing-bar strip or the bearing- and cross-bar strip is hot-dip galvanized in a continuous process.

3. Method according to claim 1, characterised in that the cutting punch for punching the bearing bars or the bearing and cross bars is configured as a longish, flat element (1) that features rotationally symmetric reductions (2) at its upper and lower free ends.

4. Method according to claim 4, characterised in that, in the area adjacent to each of the areas with the smaller cross-section, the cutting punch features a depression (3) which is on the opposite side to that featuring a reduction (2).

5. Method according to claim 1, characterised in that for banding the grating, a welding temperature is selected which is below the vaporisation temperature of zinc.

6. Method according to claim 5, characterised in that the welding method known as “MIG soldering of galvanized steels with A 202 M” is used for banding the grating.
